(19) United States
(12) Patent Application Publication
(10) Pub. No.: US 2010/0000053 A1
(43) Pub. Date: Jan. 7, 2010

(54) PORTABLE BLOWER GRIP

(75) Inventors: Keiichi Moriya, Togane-shi (JP); Junichi Miyamoto, Togane-shi (JP)

Correspondence Address: OSHA LIANG L.L.P., TWO HOUSTON CENTER, 909 FANNIN, SUITE 3500, HOUSTON, TX, 77010, US

(73) Assignee: MARUYAMA MFG. CO., INC., Tokyo (JP)

(21) Appl. No.: 12/496,371

(22) Filed: Jul. 1, 2009

(30) Foreign Application Priority Data
Jul. 3, 2008 (JP) P2008-174896

(51) Int. Cl. B25G 1/10

(52) U.S. Cl. 16/430

(57) ABSTRACT

An object is to provide a potable blower grip which can sufficiently reduce vibration and can lessen the worker's fatigue fully. A soft material grip 2, attached to a handle 1 of a portable blower 100 and held by a worker P has a corrugation 2X and the corrugation 2X is arranged so as to face in the vertical direction V, when the portable blower 100 is tilted forward to take a working posture, and thus the weight of the portable blower 100 is applied to one hand at the time of working via the corrugation 2X which faces in the vertical direction V. Accordingly, the crushing of the corrugation 2X is prevented and also the contact area between the grip 2 and the hand is minimized by the corrugation 2X to sufficiently reduce the vibration transferred to the hand.

### BACKGROUND OF THE INVENTION

1. Field of the Invention

The present invention relates to a portable blower grip.

2. Related Background Art

Conventionally, as a device easily collecting dust, fallen leaves, or the like on a road, in a park, or the like, for example, there is known a portable air blower, which is disclosed in the following patent document 1, for example. For using this portable air blower, a worker grips a handle of the potable air blower with one hand for carry and also drives an engine equipped to blow and collect dust, fallen leaves, or the like by air-blowing from an air outlet.

Here in the above portable air blower, vibration generated mainly by the engine is directly transferred from the handle to the worker's hand and becomes one factor causing worker's fatigue. Accordingly, as one of the measures for reducing the vibration which is transferred to the worker in such a portable work machine, there is known a grip for a bush cutter disclosed in the following patent document 2, for example. The bush cutter disclosed in this patent document 2 has a configuration in which a grip made of an elastic material is attached to a main pipe which corresponds to the handle and only both ends of the grip contact the main pipe, while the part between both ends of the grip has a gap against the main pipe and does not contact the main pipe. Therefore, the vibration from the main pipe is not directly transferred to the part between both ends of the grip and transferred to the worker's hands after having been attenuated at both ends of the grip which is made of the elastic material. As a result, the worker is supposed not to feel strong vibration.

Patent document 1: Japanese Patent Application Laid-Open Publication No. H8-200064

Patent document 2: Japanese Patent No. 2878679

### SUMMARY OF THE INVENTION

In the case of the grip disclosed in the above patent document 2, however, the reduction of the vibration is not sufficient and the worker's fatigue cannot be fully reduced.

The present invention has been achieved for solving such a problem, and it is an object of the present invention to provide a grip for a portable bower including a portable air blower, the grip which can sufficiently reduce vibration and lessen the worker's fatigue fully.

A grip for a portable blower according to the present invention which is attached to a handle of the portable blower and is a soft material grip held by a worker, is provided with a corrugation which faces in the vertical direction when the portable blower is tilted forward to take a working posture.

According to such a grip of the portable blower, since the soft material grip, which is attached to the handle of the portable blower and held by the worker, has the corrugation and the corrugation is arranged to face in the vertical direction when the portable blower is tilted forward to take a working posture, the weight of the portable blower is applied to the hand via the corrugation facing in the vertical direction at the time of working, and thus the crushing of the corrugation is prevented and also a contact area between the grip and the hand is minimized by the corrugation. As a result, the vibration transferred to the hand is sufficiently reduced and the fatigue of the worker is fully lessened.

Note that, when the corrugation is slanted from the vertical direction at the time of working, the weight of the portable blower is applied to the hand via the corrugation slanted from the vertical direction, and thus the corrugation is crushed, resulting in that the contact area between the grip and the hand is largely increased and the anti-vibration effect becomes reduced.

Here, when the grip is provided with a plurality of protrusions on the inner surface and the top surfaces of the protrusions locally contact with the outer surface of the handle, the vibration transferred from the handle to the grip is reduced compared to the case where the outer surface of the handle and the inner surface of the grip entirely contact each other, and thus the vibration transferred to the hand is far more reduced and the fatigue of the worker is further lessened.

As described above, according to the present invention, it becomes possible to sufficiently reduce the vibration and lessen the worker's fatigue fully.

### BRIEF DESCRIPTION OF THE DRAWINGS

FIG. 1 is a side view showing a portable blower according to an embodiment of the present invention.

FIG. 2 is a perspective view showing the handle and the grip shown in FIG. 1.

FIG. 3 is a perspective view showing a cross-section of the handle shown in FIG. 2.

FIG. 4 is a perspective view showing a cross-section of the grip shown in FIG. 2.

FIG. 5 is a diagram showing a state that a worker is using the portable blower shown in FIG. 1.

### DESCRIPTION OF THE PREFERRED EMBODIMENT

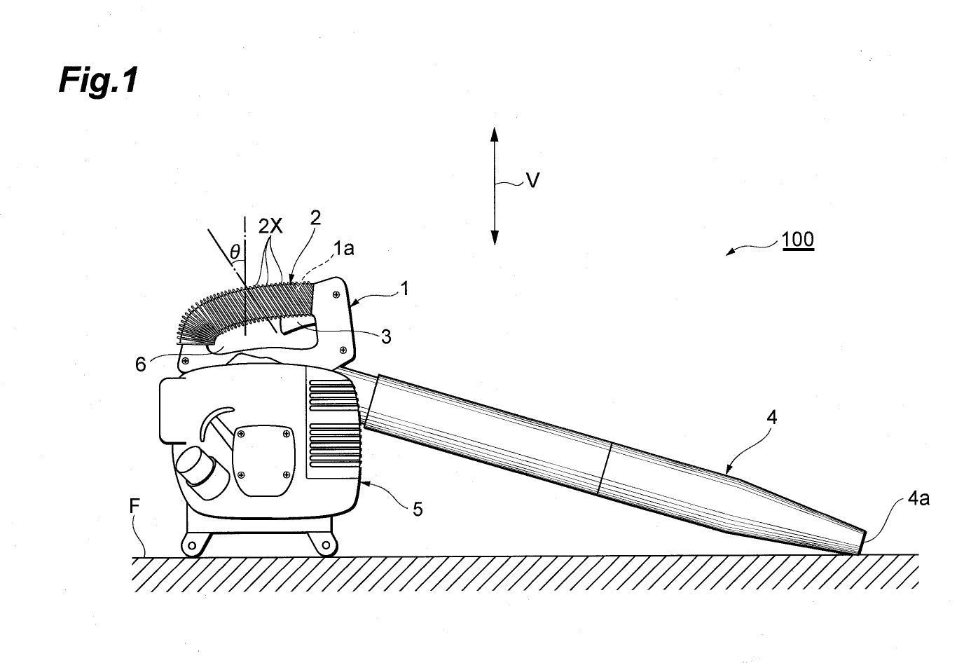

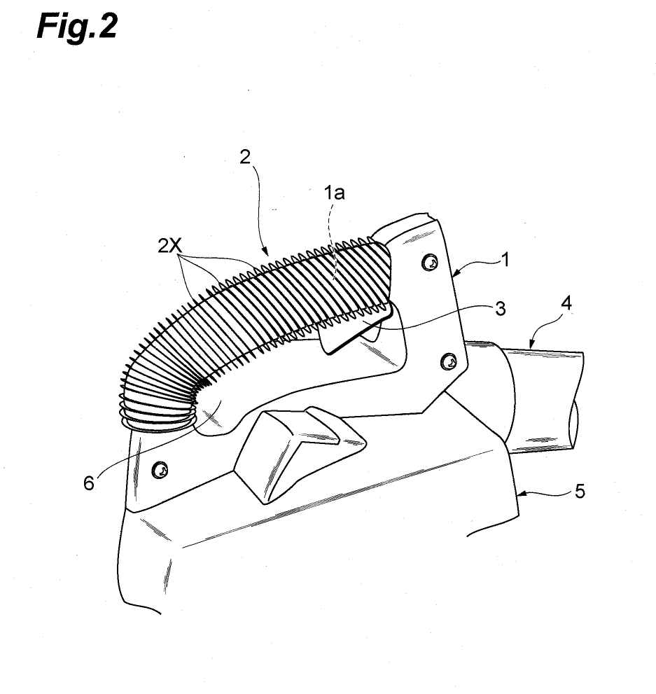

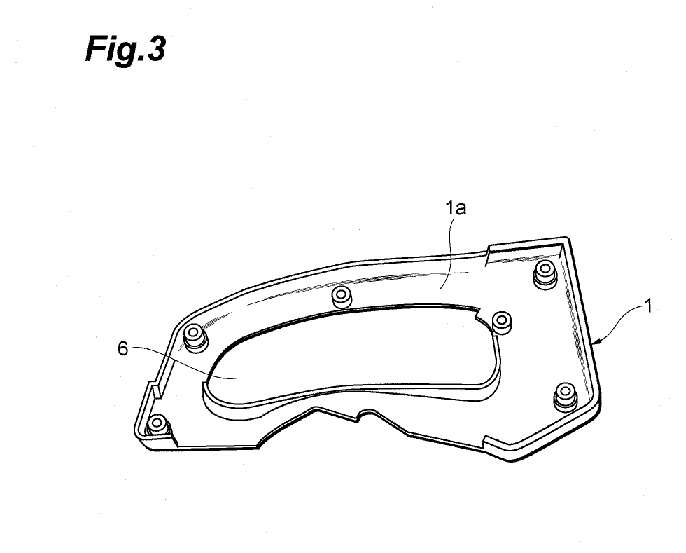

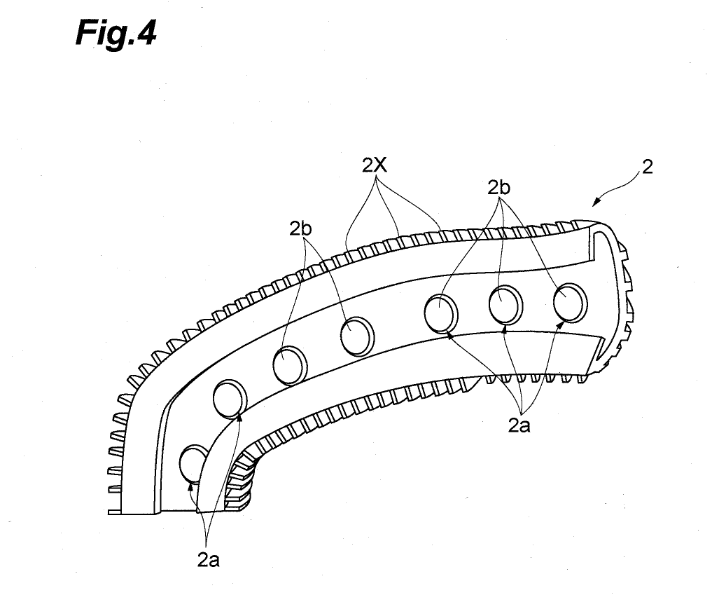

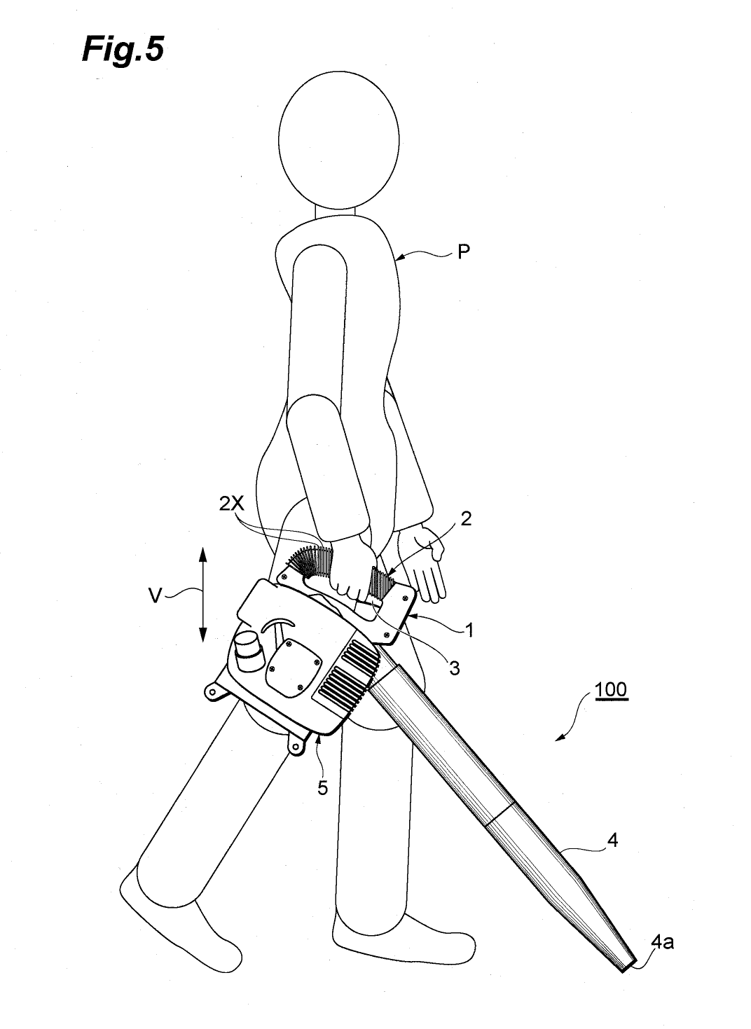

Hereinafter, a preferred embodiment of a portable blower grip according to the present invention will be explained with reference to the accompanying drawings. FIG. 1 is a side view showing the portable blower according to the embodiment of the present invention, FIG. 2 is a perspective view showing the handle and the grip shown in FIG. 1, FIG. 3 is a perspective view showing a cross-section of the handle shown in FIG. 2, FIG. 4 is a perspective view showing a cross-section of the grip shown in FIG. 2, and FIG. 5 is a diagram showing a state that a worker is using the portable blower shown in FIG. 1. The portable blower (also referred to as “handy blower”) according to the present embodiment has a function of an air blower which blows and collects dust, fallen leaves, or the like by air blow.

Specifically, as shown in FIG. 1, the portable blower 100 in outline is provided with a main body 5 which generates wind, a blow-out pipe 4 which sends and blows out wind generated by this main body 5, and a handle 1 which is a holder for carrying the main body 5.

The main body 5 is configured to be a handy type, accommodates an engine (not shown in the drawing) therein, and generates wind by driving the engine.

The blow-out pipe 4 is connected to an upper front part of the main body 5, and sends wind generated in the main body 5 to the blow output 4a at the front end thereof. This blow output 4a of the blow-output pipe 4 is configured to have a nozzle shape easily for collecting dust, fallen leaves, or the like.

The handle 1 is a solid body provided to the upper part of the main body 5 as shown in FIG. 1 to FIG. 3, and configured to have a ring shape (loop shape) such that the worker puts in his hand to hold the handle 1 and carry the main body 5 with one hand. Further, on the front side of the space 6 for the hand insertion inside the handle 1, a throttle lever 3 is movably provided for controlling a rotation number of the engine, as shown in FIG. 1 and FIG. 2.

This handle 1 is provided with a soft material grip 2 attached for reducing vibration. This grip 2 is made of rubber or the like, for example, and is attached so as to cover a holder part 1a (refer to FIG. 3) which constitutes the upper part of the handle 1 to be held by the worker P.

Here, particularly in the present embodiment, the grip 2 is provided with a number of parallel corrugations 2X which have convex and concave portions toward the outside as shown in FIG. 1, FIG. 2, and FIG. 4.

These corrugations 2X are provided so as to form a slanted direction (extends in a slanted direction) having a predetermined angle θ backward against the vertical direction V when the portable blower 100 is placed horizontally on the ground (floor) F or the like, as shown in FIG. 1. In other words, as shown in FIG. 5, the corrugations 2X are provided so as to direct in the vertical direction (extend in the vertical direction) when the portable blower 100 is carried by the worker P with one hand and tilted forward to take a working posture at the time of working (set in a working state).

Further, the grip 2 is provided with a plurality of protrusions 2a on the inner surface thereof as shown in FIG. 4 and is attached to the handle 1 in a state where the top surfaces 2b of the protrusions 2a locally contact the outer surface of the handle 1.

When using the portable blower having such a configuration, the worker P holds the grip 2 of the portable blower 100 in one hand and sends air from the blow output 4a via the blow-out pipe 4 to blow and collect dust, fallen leaves, or the like, while increasing the rotation number of the engine to control the air blow amount by operating the throttle lever 3.

At this time, as shown in FIG. 5, the worker P tilts the portable blower 100 held in one hand via the grip 2 forward to take a working posture, and works while keeping this tilted forward.

Here, in the present embodiment, the corrugation 2X faces in the vertical direction V at the time of working. Therefore, the weight of the portable blower 100 is applied to the hand via the corrugation 2X directing in the vertical direction V, and thus the crushing of the corrugation 2X is prevented and also the contact area between the grip 2 and the hand is reduced by the corrugation 2X. As a result, the vibration transferred to the hand is sufficiently reduced and the fatigue of the worker P is fully lessened.

Further, in the present embodiment, since the grip 2 is provided with the plurality of protrusions 2a on the inner surface thereof, and the top surfaces 2b of these protrusions 2a locally contact the outer surface of the handle 1, the vibration transferred from the handle 1 to the grip 2 is reduced compared to the case where the outer surface of the handle 1 and the inner surface of the grip 2 entirely contact each other. Therefore, the vibration transferred to the hand is far more reduced and the fatigue of the worker P is further lessened.

For comparison, when the corrugation is slanted against the vertical direction V at the time of working, the weight of the portable blower 100 is applied to the hand via the corrugation slanted against the vertical direction V and thereby the corrugation is crushed, resulting in that the contact area between the grip 2 and the hand is largely increased and the anti-vibration effect becomes reduced.

While the present invention is specifically explained hereinabove based on the embodiment thereof, the present invention is not limited to the above embodiment. For example, while the above embodiment describes the application to the portable blower 100 which is provided with a function of a potable air blower which performs the blow-out by using the blow-out pipe 4, the present invention can also be applied to a portable blower which performs suck-in by using a suck-in pipe, or a portable blower which can be selectively equipped with a blow-out pipe or a suck-in pipe and can selectively perform blow-out or suck-in.

What is claimed is:

1. A portable blower grip which is a soft material grip, attached to a handle of a portable blower and held by a worker, the portable blower grip comprising
a corrugation facing in the vertical direction when the portable blower is tilted forward so as to take a working posture.

2. The portable blower grip according to claim 1, further comprising
a plurality of protrusions on an inner surface thereof,
wherein top surfaces of the protrusions locally contact an outer surface of the handle.
